(19) United States
(12) Patent Application Publication
(10) Pub. No.: US 2005/0248156 A1
(43) Pub. Date: Nov. 10, 2005

(54) Structure lamp pipe insert connector

(76) Inventor: Pi-hua Hsieh, Changhua City (TW)

Correspondence Address: TROXELL LAW OFFICE PLLC, SUITE 1404, 5205 LEESBURG PIKE, FALLS CHURCH, VA, 22041, US

(21) Appl. No.: 10/838,195

(22) Filed: May 5, 2004

(51) Int. Cl. F16L 25/00

(52) U.S. Cl. 285/397; 403/300; 403/307

(57) ABSTRACT

An improved structure lamp pipe insert connector comprised of a locking connector component situated between upper and lower lamp pipes, the locking connector component comprised of a threaded rod, a lock sleeve fastened onto the threaded rod, and constraining rings respectively sleeved (not fastened) onto the two ends of the threaded rod and, furthermore, situated at the two sides of the lock sleeve. The interior of the constraining ring is a sloped surface and a plurality of detent slots are disposed along its inner circumferential extent and, after a spring is prepositioned on the sloped surface, it is then sleeved onto the threaded rod. Furthermore, there are revolving guide ring elements with beveled sides, each revolving guide ring element having guide blocks aligned with the constraining ring detent slot positions and capable of entry into the detent slots, thereby providing for the synchronous rotation of the revolving guide ring elements and the constraining rings. When the lamp pipes drive the constraining rings into rotation, the revolving guide ring element beveled sides are forced against the constraining ring sloped surfaces and become tightly ensconced within the inner circumference of the lamp pipes. As such, assembly is simple and enables user self-assembly and, furthermore, since each steel pipe can be disassembled, shipping dimensions are minimized.

### BACKGROUND OF THE INVENTION

1) Field of the Invention

The invention herein relates to an improved structure lamp pipe insert connector comprised of a locking connector component in which the interior of each constraining ring is a sloped surface and after a spring is prepositioned on the sloped surface, it is then sleeved onto a threaded rod and furthermore, there are revolving guide ring elements with beveled sides, each said revolving guide ring element having guide blocks aligned with the detent slot positions of constraining rings and capable of entry into the detent slots, thereby providing for the synchronous rotation of the revolving guide ring elements and the constraining rings such that constraining ring circumferential edges gradually expand outward and become tightly ensconced within the inner circumference of the lamp pipes; as such, assembly is simple and enables user self-assembly and, furthermore, since each steel pipe can be disassembled, shipping dimensions are minimized.

2) Description of the Prior Art

Conventional lamp pipe insert connector structures consist of inner and outer lamp pipes that are fitted together, following which screws are installed in the fitted section to thereby fix the two pipe members. However, such a fixing method requires the forming of stepped edges (due to differing pipe dimensions) on the pipes, resulting in the drawback of unattractive pipe members. In view of this, the applicant of the invention herein conducted extensive research which following repeated testing and refinement culminated in the successful development of the improved structure lamp pipe insert connector of the invention herein.

### SUMMARY OF THE INVENTION

The invention herein provides an improved structure lamp pipe insert connector comprised of a locking connector component situated between upper and lower lamp pipes, the said locking connector component comprised of a threaded rod, a lock sleeve fastened onto the threaded rod, and constraining rings respectively sleeved (not fastened) onto the two ends of the threaded rod and, furthermore, situated at the two sides of the lock sleeve, wherein the interior of the constraining ring is a sloped surface and a plurality of detent slots are disposed along its inner circumferential extent and, after a spring is prepositioned on the sloped surface, it is then sleeved onto the threaded rod. Furthermore, there are revolving guide ring elements with beveled sides, each said revolving guide ring element having guide blocks aligned with the constraining ring detent slot positions and capable of entry into the detent slots, thereby providing for the synchronous rotation of the revolving guide ring elements and the constraining rings; and when the lamp pipes drive the constraining rings into rotation, the revolving guide ring elements force the constraining rings to expand outward and become tightly ensconced within the inner circumference of the lamp pipes; as such, assembly is simple and enables user self-assembly and, furthermore, since each steel tube can be disassembled, shipping dimensions are minimized.

To enable the examination committee a further understanding of the structure, features, functions, and other objectives of the present invention, the brief description of the drawings below are followed by the detailed description of the invention herein.

### BRIEF DESCRIPTION OF THE DRAWINGS

FIG. 1 is an exploded drawing of the invention herein.

FIG. 2 is an isometric drawing of the invention herein.

FIG. 3-A is a cross-sectional drawing of the lamp pipes and the lock sleeve before tightening.

FIG. 3-B is a cross-sectional drawing of the lamp pipes and the lock sleeve after tightening.

FIG. 4 is an isometric drawing the invention herein as utilized for assembling a lamp.

### DETAILED DESCRIPTION OF THE INVENTION

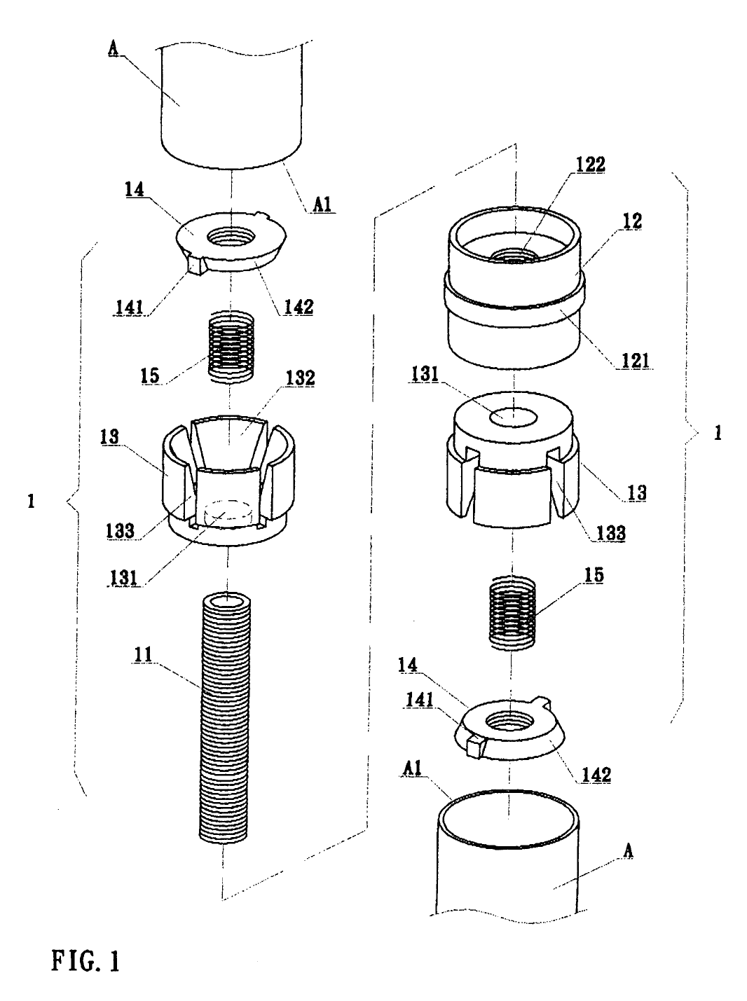

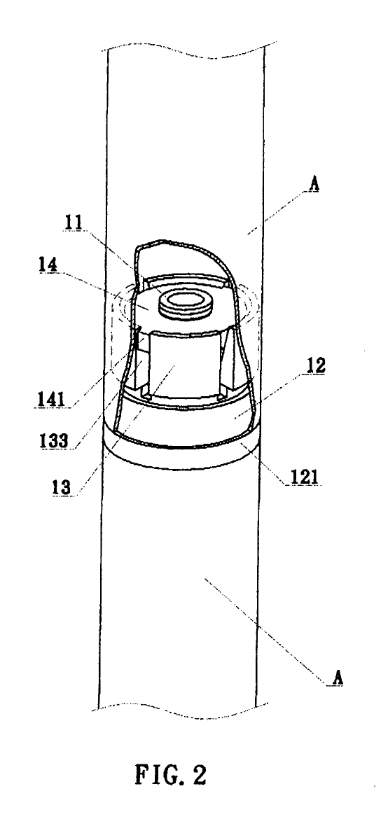

Referring to FIG. 1 and FIG. 2, the structural arrangement of the invention herein is comprised of a locking connector component 1 situated between upper and lower lamp pipes A, the said locking connector component 1 comprised of a threaded rod 11, a lock sleeve 12 fastened at the center onto the threaded rod 11, and constraining rings 13 respectively sleeved onto the upper and lower ends of the threaded rod 11 and, furthermore, situated at the two sides of the lock sleeve 12.

The said lock sleeve 12 has an annular band 121 protruding along the center portion of its circumferential surface that provides for the bottoming of the ensleeved extremities A1 of the upper and lower lamp pipes A after their entry; additionally, a threaded hole 122 is formed through the center of the lock sleeve 12 that provides for the fastening of the threaded rod 11.

Each said constraining ring 13 has a hole 131 (for insertion only, not fastening) through the center that provides for the insertion of the threaded rod 11, the interior of each constraining ring 13 is a sloped surface 132, and a plurality of detent slots 133 are disposed along the inner circumferential extent, and after a spring 15 is prepositioned onto the sloped surface 132, it is then sleeved onto the threaded rod 11 and, furthermore, there are revolving guide ring elements 14 with beveled sides 142, each said revolving guide ring element 14 having guide blocks 141 aligned with the constraining ring 13 detent slot 133 positions and capable entry into the detent slots 133, thereby providing for the synchronous rotation of the revolving guide ring elements 14 and the constraining rings 13, and when the lamp pipes A drive the constraining rings 13 into rotation, the revolving guide ring element 14 beveled sides 142 are forced against the constraining ring 13 sloped surfaces 132, and become tightly ensconced within the inner circumference of the lamp pipes A.

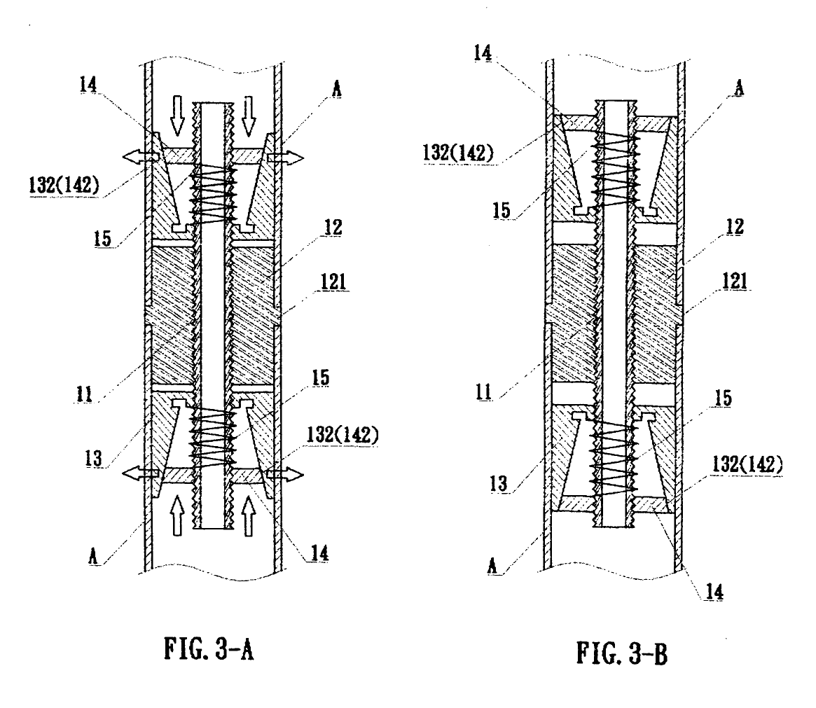

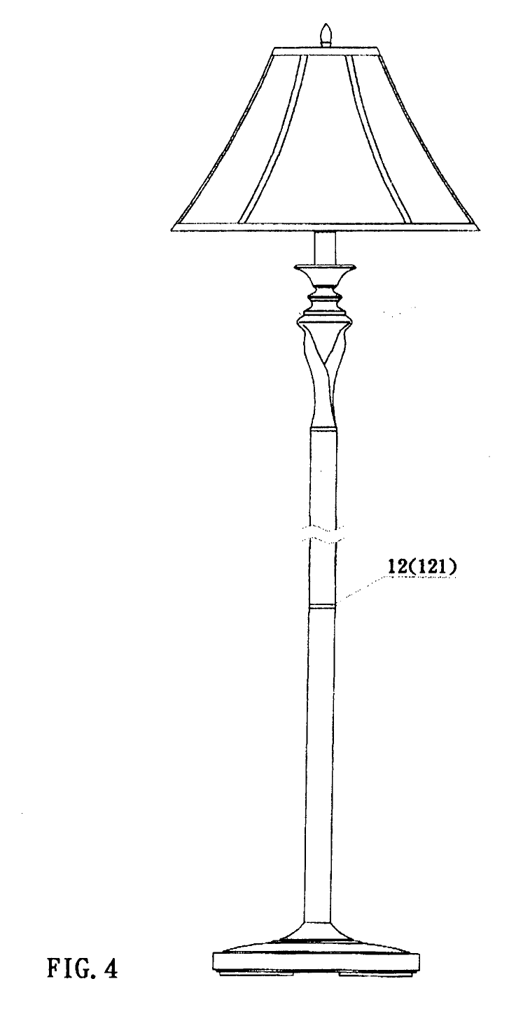

As for the assembly and operating method, referring to FIG. 3 and FIG. 4, after the lock sleeve 12 and the threaded rod 11 are first fastened, the constraining rings 13 are then respectively sleeved onto the threaded rod 11 at the each of the two sides of the lock sleeve 12 and, furthermore, the springs 15 and the revolving guide ring elements 14 are already fastened onto the threaded rod 11 and at the upper extent of the constraining rings 13; each lamp pipe A is respectively ensleeved at a slight degree of tightness outside the constraining rings 13 such that the lamp pipes A are capable of driving the constraining rings 13 into synchronous rotation; when the lamp pipes A drive the constraining rings 13 into rotation, the constraining rings 13 drive the insertionally locking, revolving guide ring elements 14 into synchronous rotation, such that since the revolving guide ring elements 14 are fastened onto the threaded rod 11, their beveled sides 142 gradually move against the constraining ring 13 sloped surfaces 132, the constraining ring 13 circumferential edges expand outward against the lamp pipe A inner circumferences, the lamp pipes A and the lock sleeve 12 becoming firmly positioned (as shown in FIG. 3-A); and when the lamp pipes A drive the constraining rings 13 into rotation in the opposite direction, the constraining ring 13 sloped surfaces 132 are gradually released from the revolving guide ring element 14 beveled sides 142, enabling the thrust of the springs 15 to separate the constraining rings 13, thereby facilitating the separation of the lamp pipes A and the constraining rings 13 for removal (as shown in FIG. 3-B).

As such, assembly is simple and enables user self-assembly and, furthermore, since each steel pipe can be disassembled, shipping dimensions are minimized,

1-3. (canceled)

4. A locking connector component located between and connecting an upper lamp pipe and a lower lamp pipe, the locking connector component comprising:
a) a threaded rod;
b) a lock sleeve fastened onto the threaded rod;
c) two constraining rings, one of the two constraining rings is located on each of two opposing sides of the lock sleeve and positioned within each of the upper lamp pipe and the lower lamp pipe, each of the two constraining rings having:
i) a hole located through a center thereof, the threaded rod is inserted through the hole;
ii) a sloped surface located on an interior thereof; and
iii) a plurality of detent slots located through a peripheral wall;
d) two revolving guide ring elements threadedly connected to the threaded rod, each of the two revolving guide ring elements having beveled sides and guide blocks, each of the guide blocks aligning with one of the plurality of detent slots, each of the two revolving guide ring elements synchronously rotating with one of the two constraining rings; and
e) two springs, the threaded rod is inserted through each of the two springs, each of the two springs is located between one of the two constraining rings and one of the two revolving guide ring elements,
wherein, when the upper lamp pipe and the lower lamp pipe are rotated in a first direction, the two constraining rings are rotated in the first direction, the beveled sides of the each of the two revolving guide ring elements engage the sloped surface of one of the two constraining rings, an outer periphery of one of the two constraining rings engaging an interior of each of the upper lamp pipe and the lower lamp pipe, and, when the upper lamp pipe and the lower lamp pipe are rotated in a second direction, the two constraining rings are rotated in the second direction, one of the two springs presses each of the two revolving guide ring elements away from one of the two constraining rings, an outer periphery of one of the two constraining rings releases the interior of each of the upper lamp pipe and the lower lamp pipe.

5. The locking connector component according to claim 4, wherein the lock sleeve includes an annular band protruding from a center portion of an outer peripheral surface thereof, the annular band being located between an end of the upper lamp pipe and an end of the lower lamp pipe.

6. The locking connector component according to claim 4, wherein the lock sleeve includes a threaded hole through a center thereof, the threaded rod being threadedly connected to the threaded hole.
